(19) United States
(12) Patent Application Publication
(10) Pub. No.: US 2006/0065307 A1
(43) Pub. Date: Mar. 30, 2006

(54) Gas pressure regulator having a vibration damping abutment

(76) Inventors: J. Schmidt, Wetter (DE); V. Schneider, Frankenberg/Eder (DE)

Correspondence Address: LAW OFFICES OF JAMES E. WALTON, PLLC, 1169 N. BURLESON BLVD., SUITE 107-328, BURLESON, TX, 76028, US

(21) Appl. No.: 11/238,397

(22) Filed: Sep. 29, 2005

(30) Foreign Application Priority Data
Sep. 30, 2004 (EP) EP 04104800.0

(51) Int. Cl. G05D 11/00

(52) U.S. Cl. 137/505.46; 137/116.5; 137/505.47

(57) ABSTRACT

A gas pressure regulator has in the regulator housing (12) a damping abutment (38) adapted to be engaged, in open position of the regulator, by an actuating shaft (22) fixed to a regulator diaphragm (16) for damping vibrations of the regulator mechanism.

This application claims the benefit under 35 U.S.C. § 119 of European Patent Application No. EP 04104800.0 filed 30 Sep. 2004.

### BACKGROUND OF THE INVENTION

1. Field of the Invention

The invention relates to a gas pressure regulator having a regulator housing and a regulator mechanism disposed within the regulator housing and comprising a spring-loaded diaphragm which is adjustable against the spring force by the gas pressure to be regulated, and a regulator linkage including an actuating shaft fixed to the diaphragm, and a regulator piston which is adjustable by the actuating shaft with respect to a regulator seat.

2. Description of the Prior Art

Gas pressure regulators are known in the state of the art and are commonly used as gas pressure reducing valves in domestic gas supply systems. In the known gas pressure regulators of this type vibrations of the movable regulator parts in the open condition of the regulator have been encountered, producing during operation of the regulator a rattling noise caused by repeated impact of the sealing body on the regulator seating surface. This noise is annoying and moreover these vibrations cause a reduction of the durability and accuracy of the regulator. To attenuate the vibrations it has already been proposed to guide a regulator lever in a generally U-shaped forked member, but this causes a permanent frictional resistance which is effective in all positions of the regulator lever, i.e. also in operating conditions wherein vibration damping is in fact not needed.

### SUMMARY OF THE INVENTION

The object of the invention is to provide a gas pressure regulator of the type referred to, provided with an improved vibration damping device which is only effective in the operating conditions in which the vibrations predominantly appear.

To achieve this object of the invention the gas pressure regulator of the type above referred to is provided in the regulator housing with at least one damping abutment adapted to be engaged by the actuating shaft in the open position of the regulator for damping vibrations of the regulator mechanism by frictional contact between the actuating shaft and the damping abutment, the actuating shaft, in the closed position of the regulator, being spaced a predetermined distance form the damping abutment so as to be free therefrom.

In the gas pressure regulator according to the invention the regulator linkage is not dampened by the guidance of the lever in a generally U-shaped fork, but by engagement, in the regulator open position, of the actuating shaft with a damping abutment. Normally, the actuating shaft is not in contact with the damping abutment, but engages the damping abutment only in the regulator open position due to the gas stream caused inclination or tilting of the shaft, and a frictional contact between the shaft and the damping abutment is therefore provided only in the operating condition in which the vibrations of the regulator mechanism predominantly appear. Accordingly excessive wear of the regulator parts is avoided and the regulator accuracy is improved.

One or two damping abutments in form of a damping rib may be provided. The damping rib or ribs can be formed integrally with the regulator housing or may be removably and adjustably fixed to the housing. The adjustable fixing permits to effectuate an adjustment of the distance between the actuating shaft and the damping rib or ribs when the regulator is closed and to determine exactly in the closed position of the regulator the position of the regulator linkage at which the shaft comes into engagement with the damping rib or ribs. Moreover, wear of the regulator parts during the life-time of the regulator can be compensated.

Preferably, there is provided on both sides of the regulator lever one damping rib, with both ribs being transversely or laterally spaced from their regulator lever. Both ribs may be parts of a U-shaped damping element which is adjustably fixed to the housing.

In order to increase the damping effect there may be provided on the surface of the damping rib, which cooperates with the actuating shaft, a friction facing of rubber or another material having a high coefficient of friction. The regulator housing and the actuating shaft as well as the lever are preferably formed of die-casting zinc alloy (Zamak), a known material also used for carburetor parts.

Further, a wing may be fixed to the regulator lever to urge the regulator lever into its open position responsive to the gas flow pressure to provide a higher gas flow rate.

A gas pressure regulator according to the state of the art usually has only one gas outlet for connecting the regulator to a consumer supply line. For purging the gas system and also to determine whether the system is gas-tight, it was heretofore necessary to disconnect the regulator from the supply line to permit connection of purging devices or gas pressure control devices to the regulator. To avoid this disadvantage the regulator housing of the gas pressure regulator preferably has two outlets arranged with respect to one another at an angle of for example 90°, a first of said outlets being preferably coaxial with the gas inlet. One of these outlets is provided for connection to the supply line and the other outlet is normally closed by plug, and has a connector for a pressure control device, such as a pressure gauge or a purging device. The consumer supply line and the plug with the connection for the pressure gauge or pressure controller may be selectively connected to the one or the other gas outlet.

### BRIEF DESCRIPTION OF THE DRAWINGS

The gas pressure regulator will now be described in greater detail with reference to the drawings, wherein:

FIG. 1 shows the gas pressure regulator of the invention in a vertical sectional view;

FIG. 2 shows the gas pressure regulator according to the invention along line 2-2 of FIG. 1 in a section plane oriented normally to the section plane of FIG. 1;

FIG. 3 shows the lower housing part in perspective view, without the upper housing part, the regulator diaphragm and the regulator springs;

FIGS. 4A, 4B, 4C and 4D show the cooperation between the actuating shaft and the damping ribs;

FIGS. 5A, 5B and 5C show another embodiment of the regulator with an adjustable damping element; and

FIGS. 6A, 6B, 6C and 6D show the regulator linkage provided with a wing on the regulator lever.

### DESCRIPTION OF THE PREFERRED EMBODIMENTS

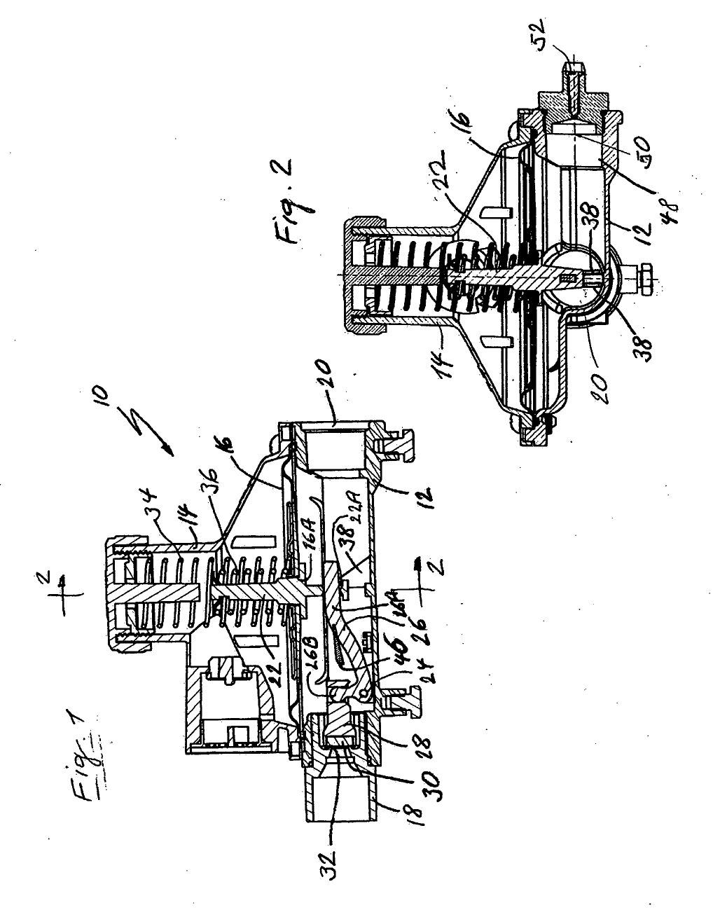

The gas pressure regulator 10 shown in FIG. 1 has a housing consisting of a lower housing part 12 and upper housing part 14. A diaphragm 16 is tightly clamped between the lower housing part 12 and the upper housing part 14. The lower housing part 12 has in inlet opening into which an inlet connector 18 is threadably engaged. Positioned diametrally opposite the inlet connector 18 is an outlet opening 20 to which a consumer supply line (not shown) may be connected.

The regulator 10 has a regulator linkage consisting of an actuating shaft 22 received in a central through opening 16A of the diaphragm 16 and fixedly attached thereto, a lever 26 pivotably mounted at 24 to the lower housing part 12, and a piston 28 provided with a seal 30 which engages a seat 32 of the inlet connector in the closed position of the regulator. The actuating shaft 22 has a lower portion provided under the diaphragm 16 and an upper portion extending through the diaphragm into the upper housing part 14. In the upper housing part 14 above the diaphragm 16 there are provided regulator springs 34 and 36. A long arm 26a of the lever 26 is received in a through opening 22a of the lower part of the shaft 22 and a short arm 26b of the lever 26 is slidably guided in a transverse bore of the piston 28. The through opening of the lever 26 has at its upper and lower ends a bearing edge to provide line contact between the shaft 22 and the lever 26 for reducing the frictional resistance.

A gas pressure regulator having these features is generally known in the state of the art and need not to be described herein in greater detail. In a rest position the regulator 10 is fully open, namely the diaphragm 16 is forced downwardly by the springs 34 and 36, the lever 26 is pivoted in clockwise direction from the position shown in FIG. 1, i.e. the large lever arm 26a is also urged downwardly by the shaft 22, and the piston 28 is moved rightwardly by the short lever arm 26b. The seal 30 is spaced from the seat 32 and the gas flows from the inlet connector 18 through the regulator 10 to the outlet 20. When the gas pressure applied to the lower side of the diaphragm 16 increases, the diaphragm 16 together with the actuating shaft 22 moves upwardly, thereby pivoting the lever 26 in counterclockwise direction and moving the piston 28 with the seal ring 30 in a direction towards the seat 32. The direction of movement of the shaft 22 is generally perpendicular to the direction of movement of the piston 28.

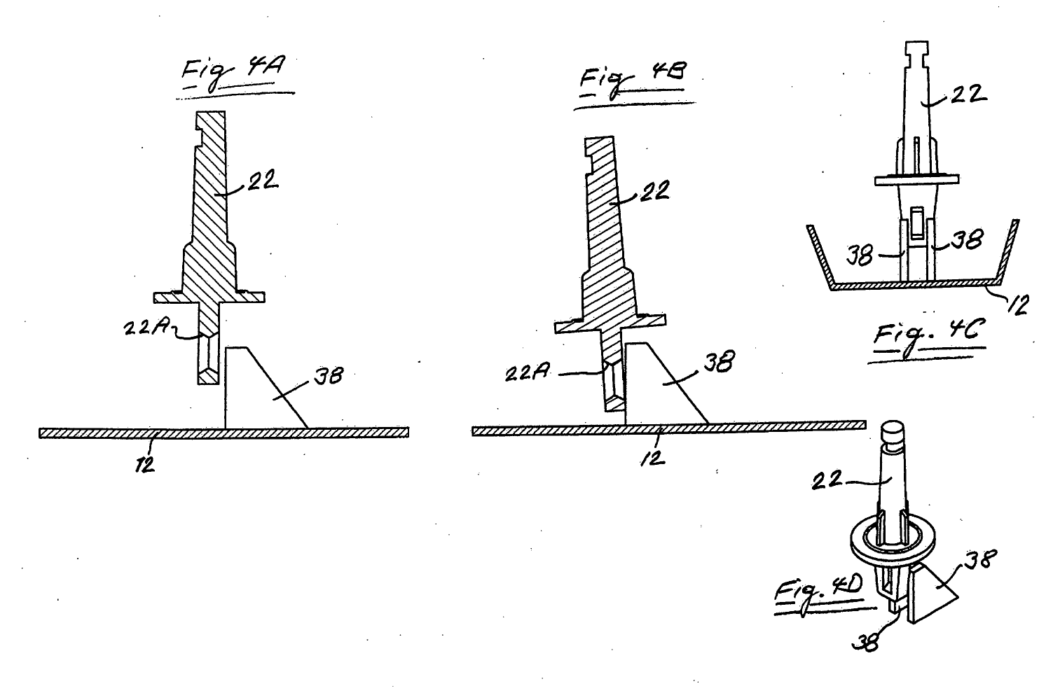

For damping vibrations or noise, which may be present in the open position of the regulator, there are provided (seen in flow direction from the inlet connector 18 to the outlet 20) in the housing lower part 12 rearwardly of the actuating shaft 22 one, preferably two fixed, thin-walled damping ribs, abutments or stops 38 which may be formed integrally with the housing and are adapted to be engaged by the shaft 22 in the open condition of the regulator, as shown in FIG. 4B. In FIG. 4B the shaft 22 is under the effect of the gas flow, tilted rearwardly against the damping ribs 38 and engages the ribs with the lower end thereof. The vibrations are damped by frictional contact between the shaft 22 and the ribs 38. In the closed position of the regulator 10 the shaft 22 is positioned vertically and there is provided a spacing or gap between the shaft 22 and the ribs 38. A frictional engagement between the shaft 22 and the ribs 38 is accordingly only present when the regulator is open, namely when vibration damping is to be achieved. The FIG. 4D shows the two ribs 38 spaced from one another and provided on both sides of the opening 22A in the lower part of the shaft 22, wherein the long lever arm 26a is received. The FIG. 4C shows that the ribs 38 are laterally spaced from the lever arm 26 and are accordingly not in contact with the lever 26. The FIG. 4D shows another perspective view of the shaft 22 and the two damping ribs 38.

In another embodiment, the lever 26 may be provided with a forked end received in two openings of the shaft. One rib 38 would then be sufficient for engaging, in the open position of the regulator, the shaft 22 between these two openings.

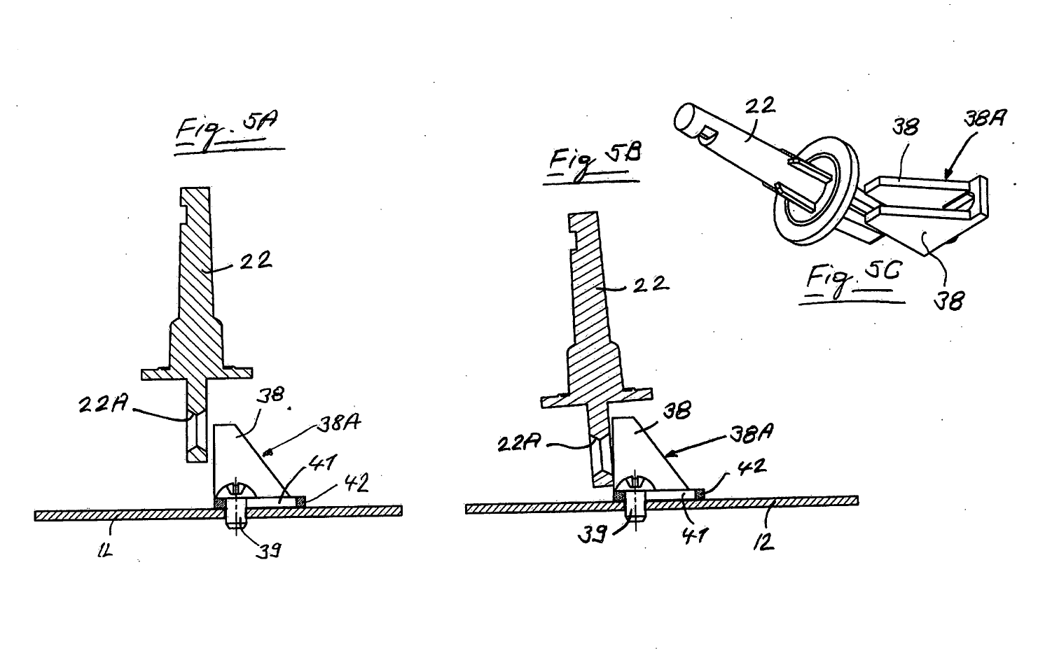

The ribs 38, 38 are arranged in the regulator housing and in one embodiment are integrally formed with the lower part 12 of the housing, i.e. are cast integrally with the housing lower part. In another embodiment, see FIGS. 5A, 5B and 5C, a damping element is releasably fixed to the lower housing part 12. The damping element is a U-member 38A whose two arms define the damping ribs 38. The U-member 38A is secured by a screw 39 to the lower housing part 12. The screw 39 extends through a hole 41 in the web 42 of the U-member 38A. The hole 41 may be elongated to permit adjustment of the ribs 38 with respect to the shaft 22 and to permit compensation for wear of the shaft 22 and the ribs 38 occurring during the lifetime of the regulator.

As shown in FIGS. 4A through 4D and 5A through 5C the ribs 38 are generally triangular or trapezoidal and are upwardly tapered. The shaft 22 engages in the regulator open position an edge surface 38a of the ribs 38 which is generally parallel to the shaft longitudinal axis, when the shaft is in the regulator closed position and is not rearwardly tilted.

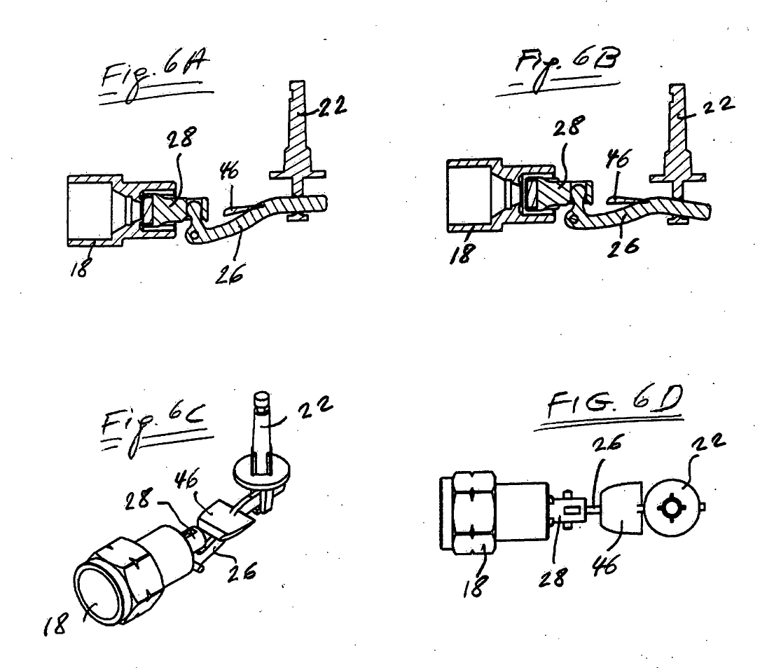

The FIGS. 6A, 6B, 6C and 6D show the regulator linkage in the closed position (6A), in the open position (6B), in perspective view (6C) and in plan view (6D). A wing 46 is attached to the lever 26 or integrally formed therewith. The gas flow impinges on the wing 46 and forces the lever 26 downwardly in order to assist the opening movement of the regulator 10. This increases the gas flow through the regulator.

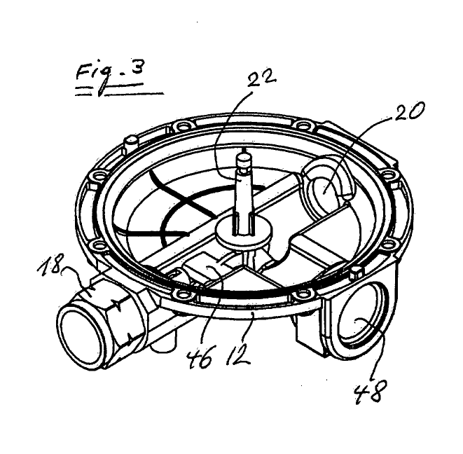

As shown in FIG. 2, the gas pressure regulator 10 has a second outlet 48 offset 90° with respect to the first outlet 20. The second outlet 48 is normally closed by a plug 50 having a connector means for an auxiliary device (not shown), such as a purging device or a pressure control device (pressure gauge). The consumer supply line (not shown) may be fixed to the first outlet 20 or to the second outlet 48. In case the consumer supply line is to be connected to the second outlet 48 only the plug 50 has to be removed from the outlet 48 and then threaded into the outlet 20. The embodiment with the two outlets 20, 48 provides the advantage that for purging or pressure checking the gas installation the consumer supply line does not have to be disconnected from the pressure regulator. In the plug 50 there is provided a threadably engaged pin 52 which has to be removed to permit connection of the auxiliary device. The FIG. 3 shows the housing lower part 12 in perspective view and provided with the inlet connector 18, the two outlets 20 and 48, the shaft 22 and the lever wing 46.

The invention is not restricted to the particular features of the embodiments described in greater detail hereinbefore, but to the contrary, modifications of these two embodiments can be made by one skilled in the art without leaving the scope of the invention as defined by the annexed claims.

What is claimed is:

1. A gas pressure regulator, comprising:
a regulator housing;
a regulator mechanism disposed within the regulator housing, said regulator mechanism comprising:
a spring-loaded diaphragm which is adjustable against a spring force by the gas pressure to be regulated;
a regulator linkage including an actuating shaft fixed to the diaphragm; and
a regulator piston which is adjustable by the actuating shaft with respect to a regulator seat; and
at least one damping abutment disposed in the regulator housing, said damping abutment being adapted to be engaged by the actuating shaft in the open position of the regulator for damping vibrations of the regulator mechanism by frictional contact between the actuating shaft and the damping abutment, the actuating shaft, in the closed position of the regulator, being spaced a predetermined distance form the damping abutment so as to be free therefrom.

2. The regulator according to claim 1, wherein the damping abutment is a damping rib.

3. The regulator according to claim 1, wherein the damping abutment is integrally formed with the housing.

4. The regulator according to claim 1, wherein the damping abutment is removably fixed to the housing.

5. The regulator according to claim 1, wherein the damping abutment is adjustably fixed to the housing.

6. The regulator according to claim 1, wherein a second damping abutment is provided on the regulator housing, said second abutment being a second rib, and the two ribs being spaced from one another in a direction transverse to the longitudinal axis of the actuating shaft and the regulator piston.

7. The regulator according to claim 1, wherein the damping abutment is a U-shaped damping element provided with two damping ribs, and being releasably fixed to the regulator housing.

8. The regulator according to claim 7, wherein the U-shaped damping element is adjustably fixed to the regulator housing.

9. The regulator according to claim 1, wherein the actuating shaft is operably connected by means of a pivotably mounted lever to the regulator piston and a lever arm of the lever is received in an opening of the actuating shaft, and wherein there is provided a damping abutment on each side of the lever, said damping abutments being laterally spaced from the lever to engage, in the open position of the regulator, the actuating shaft on both sides of the actuating shaft opening.

10. The regulator according to claim 1, wherein the damping abutment has an edge surface which is generally parallel to the shaft longitudinal axis in the closed position of the regulator.

11. The regulator according to claim 1, wherein the damping abutment is provided with a frictional coating on a surface thereof cooperating with the actuating shaft.

12. The regulator according to claim 1, wherein the actuating shaft is operably connected by means of a pivotably mounted lever to the regulator piston, and wherein there is provided a wing on the regulator lever in order to force the regulator lever into the open position responsive to the gas flow impinging on the wing.

13. The regulator according to claim 1, wherein there are provided two gas outlets on the regulator housing, one of said outlets serving for connection of the regulator to a consumer supply line, and an auxiliary device, such as one of a purging device and a pressure control device, being adapted to be connected to the other outlet.

14. The regulator according to claim 13, wherein both outlets are arranged at an angle of about 90° with respect to one another.

15. The regulator according to claim 14, wherein a first of the two gas outlets is coaxial with a gas inlet opening and the other gas outlet is at an angle of approximately 90° with respect to the first gas outlet and the gas inlet opening, respectively.

16. A gas pressure regulator, comprising:
a regulator housing; and
a regulator mechanism disposed within the regulator housing, said regulator mechanism comprising:
a spring loaded diaphragm which is adjustable against a spring force by a gas pressure to be regulated;
a regulator linkage including an actuating shaft fixed to the diaphragm; and
a regulator lever pivotably mounted on the housing and having one end operatively coupled to the actuating shaft and another end operatively coupled to a regulator piston to displace the piston with respect to a regulator seat in response to diaphragm movements;
wherein a wing member is provided on the regulator lever, said wing member being arranged so as to be in the gas stream through the regulator for the gas stream to impinge on the wing and urge the regulator lever in a direction to open the gas pressure regulator.

17. A gas pressure regulator, comprising:
a regulator housing having a lower housing part and an upper housing part; and
a spring-loaded diaphragm tightly clamped between the two housing parts, said lower housing part having a gas inlet, one side of the diaphragm being exposed to the gas pressure in the lower housing part and there being provided a regulator linkage operatively coupled to the diaphragm and to a regulator piston to control gas flow through said inlet opening into the gas pressure regulator, said lower housing part further having a first gas outlet for connection of a consumer supply line to the regulator and a second gas outlet for connection of an auxiliary device to the gas pressure regulator.

18. The regulator according to claim 17, wherein the two outlets are angularly spaced from one another circumferentially of the regulator housing.

19. The regulator according to claim 17, wherein a first of the two gas outlets is coaxially aligned with the gas inlet and the other gas outlet is arranged in an angle of approximately 90° with respect to the first gas outlet and the gas inlet, respectively, circumferentially of the regulator housing.
